(19) United States
(12) Patent Application Publication
(10) Pub. No.: US 2015/0330049 A1
(43) Pub. Date: Nov. 19, 2015

(54) COMPACTOR WHEEL HAVING MULTI-ZONE TIP CONFIGURATION

(71) Applicant: Caterpillar Inc., Peoria, IL (US)

(72) Inventors: Vinayak Ramanath UGRU, Peoria, IL (US); Thomas Marshall CONGDON, JR., Dunlap, IL (US); Chad Edward SCHIELE, St. Charles, IL (US); Mark Alan WELCH, Yorkville, IL (US)

(73) Assignee: Caterpillar Inc., Peoria, IL (US)

(21) Appl. No.: 14/595,898

(22) Filed: Jan. 13, 2015

Related U.S. Application Data
(60) Provisional application No. 61/994,582, filed on May 16, 2014.

(51) Int. Cl. E02D 3/026; B23P 15/00

(52) U.S. Cl. CPC E02D 3/0265; B23P 15/00

(57) ABSTRACT

A wheel is disclosed for use with a compactor machine. The wheel may have a rim with a first edge zone, a second edge zone, and a center zone located between the first and second edge zones. The wheel may also have a first plurality of plus tips protruding radially outward from the rim at the first edge zone, and a second plurality of paddle tips protruding radially outward from the center zone.

### RELATED APPLICATIONS

This application is based on and claims priority to U.S. Provisional Application No. 61/994,582 filed on May 16, 2014, the contents of which are expressly incorporated herein by reference.

### TECHNICAL FIELD

The present disclosure relates generally to a compactor wheel and, more particularly, to a compactor wheel having a multi-zone tip configuration.

### BACKGROUND

Compactors, such as landfill compactors and soil compactors, typically include steel wheels, which are fitted with tips that extend radially outward from the wheels to engage and compact material over which the compactors are driven. Some tips can provide longitudinal traction that helps to propel the compactor, while other tips can provide lateral traction that helps to inhibit sideways sliding of the compactor. Yet other tips can increase compaction depth, or function to cut and grid the material over which the compactor travels. Many different types of tips are available and intended for particular purposes.

U.S. Pat. No. 4,074,942 of Cochran that issued on Feb. 21, 1978 (“the '942 patent”) discloses an exemplary compactor wheel having a combination of cross-shaped tips and cutting blades (a.k.a., choppers). The cross-shaped tips provide for both longitudinal traction and lateral traction, while the blades provide both chopping functionality and longitudinal traction. In the configuration shown in the '942 patent, the cross-shaped tips are circumferentially aligned in three centrally-located sets, with one set of circumferentially aligned blades at each opposing edge of the wheel.

While the compactor wheel of the '942 patent may be appropriate for certain applications, it may not be as well suited for others. For example, the cross-shaped tips (which provide a greater amount of lateral traction) are located at a center of the wheel, where the benefit of the lateral traction cannot be fully realized. In addition, the blades (which are less substantial than the cross-shaped tips and thus wear faster) are placed at a highest wear location on the wheel. Accordingly, the blades will need to be replaced more often than the cross-shaped tips and at different times, resulting in downtime of the associated machine. In addition, some applications may benefit from a lesser number of the larger and more-expensive cross-shaped tips.

The compactor wheel of the present disclosure is directed toward overcoming one or more deficiencies of the prior art.

### SUMMARY

In one aspect, the present disclosure is directed to a compactor wheel. The compactor wheel may include a rim with a first edge zone, a second edge zone, and a center zone located between the first and second end zones. The wheel may also include a first plurality of plus tips protruding radially outward from the rim at the first edge zone, and a second plurality of paddle tips protruding radially outward from the center zone.

In another aspect, the present disclosure is directed to another compactor wheel. This compactor wheel may include a rim, and a first plurality of tips protruding radially outward from the rim. The first plurality of tips may be configured to primarily provide circumferential traction to the rim. The compactor wheel may also include a second plurality of tips protruding radially outward from the rim. The second plurality of tips may be configured to primarily provide lateral traction to the rim. A number of the first plurality of tips may be greater than a number of the second plurality of tips.

In yet another aspect, the present disclosure is directed to a method of making a compactor wheel. The method may include joining a first plurality of paddle tips to a center zone of a rim, joining a second plurality of plus tips to a first edge of the rim, and joining a third plurality of plus tips to a second edge of the rim. A number of the first plurality of paddle tips is more than a combined number of the second and third pluralities of plus tips.

### BRIEF DESCRIPTION OF THE DRAWINGS

FIG. 1 is an isometric view illustration of an exemplary disclosed wheel for use with a compactor;

FIG. 2 is a front view illustration of the wheel of FIG. 1;

FIG. 3 is an end view of the wheel of FIG. 1;

FIG. 4 is an isometric view of an exemplary disclosed tip that may be used in conjunction with the wheel of FIGS. 1-3; and

FIG. 5 is an isometric view of another exemplary disclosed tip that may be used in conjunction with the wheel of FIGS. 1-3.

### DETAILED DESCRIPTION

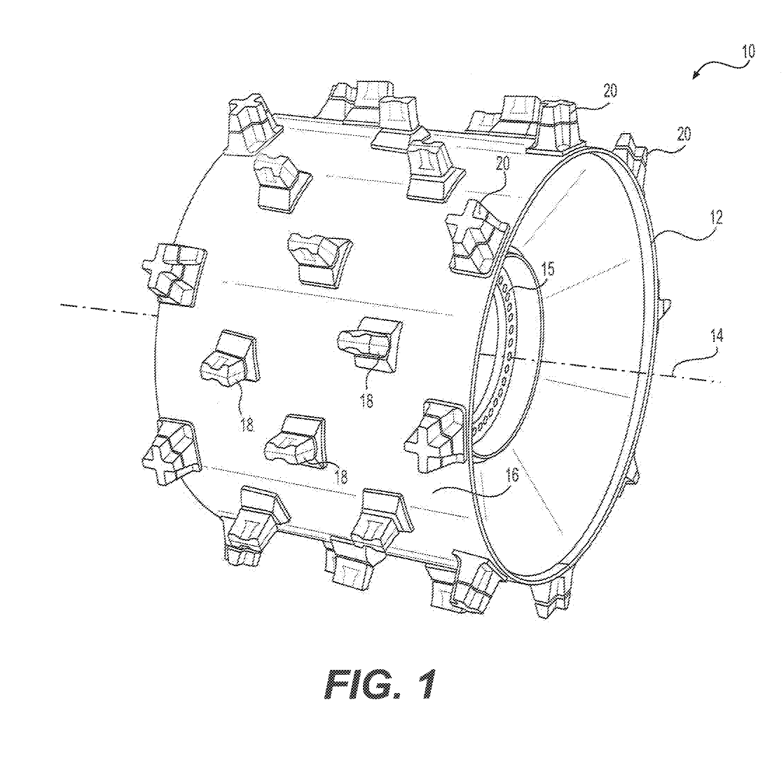

FIG. 1 illustrates an exemplary compactor wheel 10, which may be used with any type of compactor machine (e.g., a self-propelled or towed machine—not shown). Compactor wheel 10 may include, among other things, a cylindrical wheel rim 12 having an axis of rotation 14 and a mounting flange 15 oriented substantially perpendicular to axis 14. Mounting flange 15 of rim 12 may be configured to engage the end of an axle (not shown) of the associated compactor machine, and thereby transmit torque from an engine of the machine to rim 12 via the axle. An outer surface 16 of wheel 10 may function as a ground-engaging surface configured to contact the material to be compacted. In some embodiments, rim 12 may be hollow, and configured to be filled with a ballast (e.g., water) that increases its weight and compaction capability.

A plurality of tips having different designs may be arranged on surface 16. In the disclosed embodiment, two different tip designs are shown, including a plurality of “paddle” tips 18 and a plurality of “plus” tips 20. Each of these tips may extend radially outward from rim 12, and be connected to surface 16 via welding and/or threaded fastening, as desired. Although shown generally in FIG. 1 as being two-piece components (i.e., as having a base fabricated from a softer and easier-to-weld material, and a cap fabricated from a harder and more wear resistant material), it is contemplated that each of tips 18 and/or 20 may alternatively be single piece components. As two-piece components, the base and the cap of tips 18, 20 may be joined to each other via welding in a controlled environment. Thereafter, the base may be joined to surface 16 of rim 12 under field conditions.

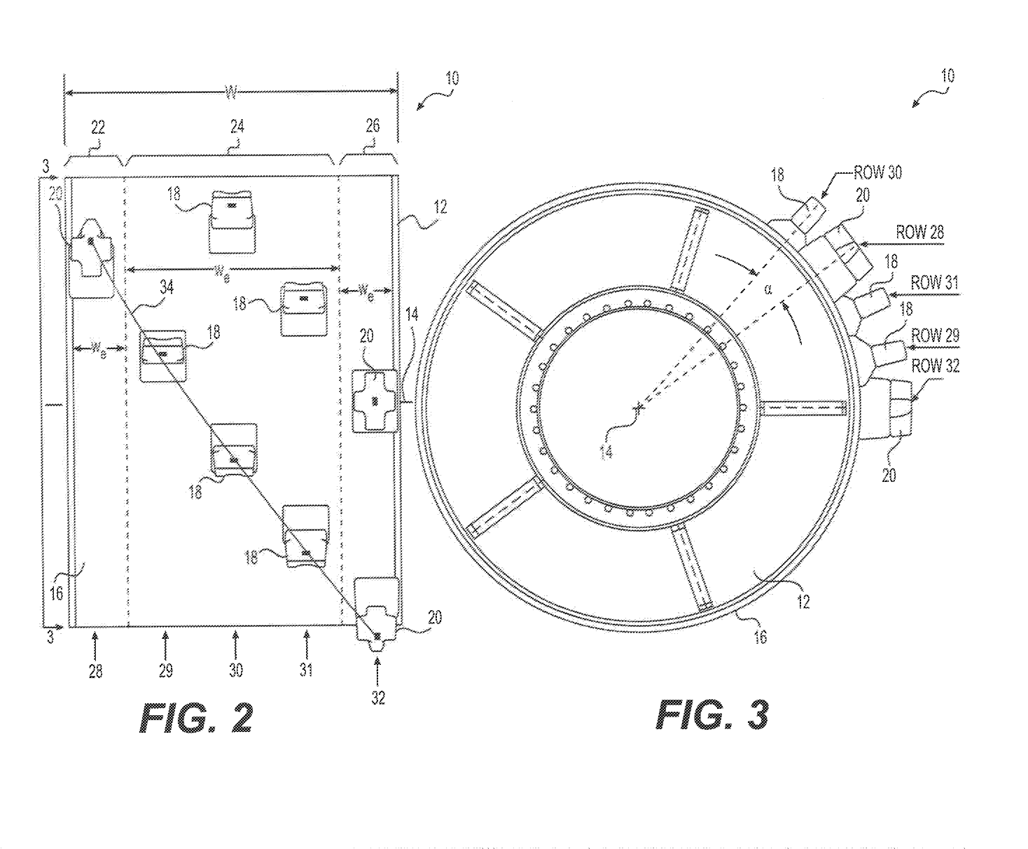

Tips 18, 20 may be arranged in a particular pattern that provides for desired compaction and traction performances. For example, surface 16 may be divided into circumferential zones, with particular tips located within each zone. In particular, surface 16 is shown in FIG. 2 as being divided into three zones, including a first or left edge zone 22, a center zone 24, and a second or right edge zone 26. Left and right edge zones 22, 26 may border (i.e., be located at opposing ends of) center zone 24, and be substantially mirror images of each other. In this example, center zone 24 may have a width w_{c} that is about three times a width wₑ of left or right edge zones 22, 26. Specifically, width w_{c} may be about 40-60% of an overall axial width W of rim 12, while width wₑ may be about 20-30% of the overall axial width W. Tips 18 may be located only within left and right edge zones 22, 26 where a greatest amount of lateral traction may be achieved, while tips 20 may be located only within center zone 24 where a lower rate of wear may be experienced. It is contemplated that surface 16 may be divided into a different number and/or configuration of zones, if desired.

Tips 18, 20 may be arranged in circumferentially aligned rows within their respective zones 22-26. For example, left and right edge zones 22, 26 may each include a single row of aligned tips 18. Center zone 24, however, may include a greater number of aligned rows of tips 20 (e.g., three rows). That is, because the width w_{c} of center zone 24 is about three times the width wₑ of left and right edge zones 22, 26, there may be about three times as many rows of tips 20 within center zone 24 as there are tips 18 within any one of left and right edge zones 18, 20. It is contemplated, however, that a different row relationship and/or configuration may be utilized, if desired. In general, the number of aligned rows within each zone may correspond with the width of the respective zones. All of the rows of tips, may be numbered 28-32 for purposes of description, starting at the left in FIG. 2 and moving to the right.

The tips of all sections may additionally be arranged in a diagonal (not shown) or helical (shown in FIG. 2) pattern. In particular, a continuous virtual line or curve 34 may be drawn through one tip 20 in left edge zone 22, three tips 18 in center zone 24, and one tip 20 in right edge zone 22. Accordingly, each row in each zone may include the same number of tips, and each of the tips may be separated by about the same angle. In the disclosed example of FIG. 3, the tips connected by a common line or curve 34 may be spaced apart by an angle α of about 10-14° (e.g., about 12°) and no tips may axially align with each other. This angular arrangement may provide an end view clocking (i.e., consecutive and repeating) tip pattern of one tip 18 from row 30, one tip 20 from row 28, one tip 18 from row 31, one tip 18 from row 29, and one tip 20 from row 32. Such a pattern and angular arrangement may provide for smooth and stable rolling of wheel 10.

A spacing of tips 18, 20 may be designed to facilitate a desired compaction performance and to reduce accumulation of debris between tips 18, 20. In the disclosed embodiment, tips 18, 20 may be arranged on surface 16, such that ratio of free space (i.e., space on surface 16 not covered by any portion of tips 18, 20) to tip space (i.e., space consumed by tips 18, 20) may be about 5:1 for a wheel 10 having an outer diameter of about 1,750 mm. A larger amount of free space may result in greater compaction, but with less longitudinal and/or lateral traction. In contrast, a smaller amount of free space may result in greater traction, but less compaction. In some embodiments, the ratio of free space to tip space may be a function of wheel diameter. In other words, the ratio of free space to tip space may reduce as the diameter of surface 16 reduces, and likewise increase as the diameter of surface 16 increases. For example, the ratio of free space to tip space may be represented by the function (d/350):1, wherein d is the diameter of surface 16.

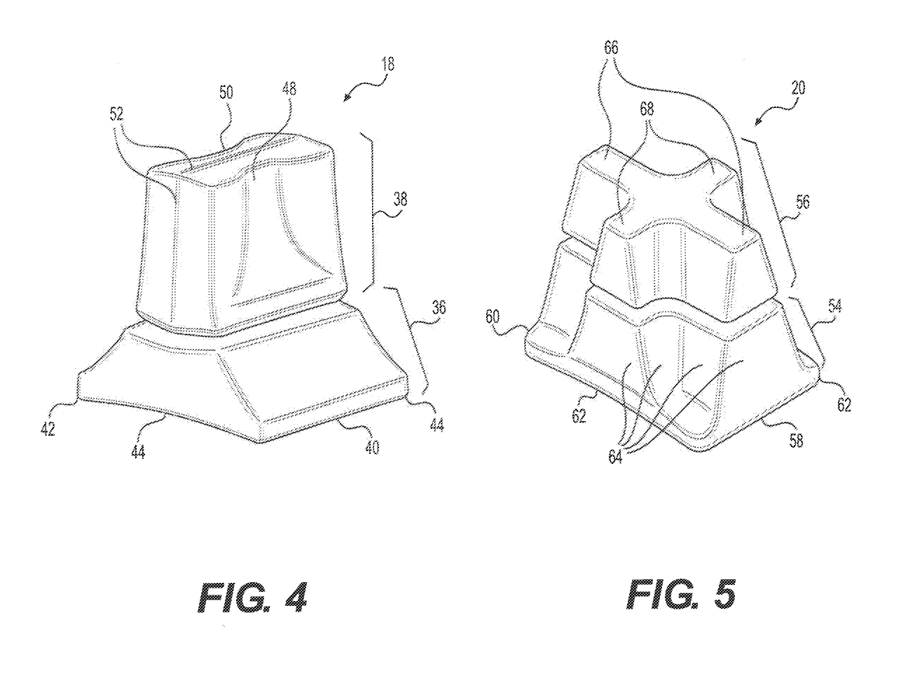

FIG. 4 illustrates an exemplary paddle tip 18. Tip 18 may include a base 36 and a cap 38. As described above, base 36 and cap 38 may be fabricated as separate components and subsequently joined together or, alternatively, fabricated as features of a single integral component. Base 36 may be generally square, having a straight leading edge 40 (relative to a rotational direction of wheel 10), a straight trailing edge 42, and opposing side edges 44 that have curvature to match a radius of surface 16 (referring to FIG. 1). A bottom surface (not shown) of tip 18 bound by edges 40-44 may be curved and shaped to conform to surface 16. External surfaces 46 of base 36 may angle or curve inward to a proximal end of cap 38. Cap 38 may protrude radially outward from base 36, and have a generally rectangular cross-section at the proximal end and a generally I-shaped cross-section at a distal end. A length of cap 38 may be generally aligned with axis 14 of rim 12 and extend between side edges 44, and a width of cap 38 may be generally perpendicular to axis 14. In the disclosed example, the length may be at least two times the width. The configuration of tip 18 may lend itself primarily to providing traction in the longitudinal direction of the corresponding compactor machine (i.e., providing propelling traction in the circumferential direction of wheel 10). Leading and trailing walls 48, 50 of cap 38 may each have a generally concave shape, such that any trash or soil engaged thereby may be cupped as wheel 10 rolls over the ground surface. A draft angle, with respect to a parting line 52, may provide cap 38 with a slight inward taper to facilitate removal of tip 18 from a corresponding mold during a casting process.

FIG. 5 illustrates an exemplary plus tip 20. Like tip 18, tip 20 may also include a base 54 and a cap 56. As described above, base 54 and cap 56 may be fabricated as separate components and subsequently joined together or, alternatively, fabricated as features of a single integral component. Base 54 may be generally square at a proximal end and plus-shaped at a distal end near cap 56. At the proximal end, base 54 may include a straight leading edge 58 (relative to a rotational direction of wheel 10), a straight trailing edge 60, and opposing side edges 62 that have curvature to match a radius of surface 16 (referring to FIG. 1). A bottom surface (not shown) of tip 20 bound by edges 58-62 may be curved and shaped to conform to surface 16. External surfaces 64 of base 54 may angle or curve inward to a proximal end of cap 56. Cap 56 may protrude radially outward from base 54, and have a generally plus-shaped cross-section. A length arm 66 of the plush shape may be generally perpendicular to axis 14 of rim 12 and extend between leading and trailing edges 58, 60, and a width arm 68 of the plus shape may be generally aligned with axis 14. In the disclosed example, width arm 68 of cap 56 may be about equal to the length of cap 38 (referring to FIG. 4), and length arm 66 may be one and one-half times as long as width arm 68. In other words, tip 20 may be longer in the circumferential direction of wheel 10 (e.g., so as to have a greater length in a direction opposing lateral sliding of Wheel 10) than in the axial direction. The configuration of tip 20 may lend itself primarily to providing traction in the lateral direction of the corresponding compactor machine (i.e., providing side-slip traction in the axial direction of wheel 10 via length arm 66), although some traction in the longitudinal direction may also be provided via width arm 68.

### INDUSTRIAL APPLICABILITY

The disclosed compactor wheel 10 may be applicable to any type of compactor machine. Wheel 10 may provide both longitudinal and lateral traction for the corresponding machine, while also balancing component life of tips 18, 20. In particular, the location of tips 20 at the side edges of wheel 10 may allow length arms 66 to have the greatest effect on machine side-slip and width arms 68 to effect drawbar power of the machine. In addition, tips 20, having a greater amount of material and being located at the wheel areas of greatest wear, may have a component life about the same as the life of the smaller tips 18 that are located at areas of lesser wear. Because of this configuration, all tips 18, 20 may be serviced during the same maintenance event, resulting in less downtime of the associated machine. Further, because fewer of the larger tips 20 may be required than the smaller tips 18, an overall cost of wheel 10 may be low.

It will be apparent to those skilled in the art that various modifications and variations can be made in the disclosed compactor wheel without departing from the scope of the disclosure. Other embodiments of the disclosed compactor wheel will be apparent to those skilled in the art from consideration of the specification and practice of the components disclosed herein. It is intended that the specification and examples be considered as exemplary only, with a true scope of the disclosure being indicated by the following claims and their equivalents.

What is claimed is:

1. A compactor wheel, comprising:
a rim having a first edge zone, a second edge zone, and a center zone located between the first and second edge zones;
a first plurality of plus tips protruding radially outward from the rim at the first edge zone; and
a second plurality of paddle tips protruding radially outward from the center zone.

2. The compactor wheel of claim 1, wherein a number of the second plurality of paddle tips is about equal to three times a number of the first plurality of plus tips.

3. The compactor wheel of claim 2, further including a third plurality of plus tips protruding radially outward from the rim at the second edge zone, wherein the number of the first plurality of plus tips is equal to a number of the third plurality of plus tips.

4. The compactor wheel of claim 3, wherein the first plurality of plus tips, the second plurality of paddle tips, and the third plurality of plus tips are arranged in a helical pattern.

5. The compactor wheel of claim 4, wherein an angular spacing between adjacent tips in the helical pattern is about 10-14°.

6. The compactor wheel of claim 3, wherein a ratio of free space to space consumed by the first plurality of plus tips, the second plurality of paddle tips, and the third plurality of plus tips is about 5:1.

7. The compactor wheel of claim 3, wherein a ratio of free space to space consumed by the first plurality of plus tips, the second plurality of paddle tips, and the third plurality of plus tips is about equal to a diameter of the rim divided by 350-to-1.

8. The compactor wheel of claim 3, wherein:
the first plurality of plus tips are arranged in a first circumferential row;
the second plurality of paddle tips are arranged in a second circumferential row, a third circumferential row, and a fourth circumferential row; and
the third plurality of plus tips are arranged in a fifth circumferential row.

9. The compactor wheel of claim 8, wherein a clock pattern when viewed from an end of the rim of the first plurality of plus tips, the second plurality of paddle tips, and the third plurality of plus tips includes one of the second plurality of paddle tips in the third circumferential row, one of the first plurality of plus tips from the first circumferential row, one of the second plurality of paddle tips from the fourth circumferential row, one of the second plurality of paddle tips from the second circumferential row, and one of the third plurality of plus tips from the fifth circumferential row.

10. The compactor wheel of claim 1, wherein each of the first plurality of plus tips has a length arm longer than a length of each of the second plurality of paddle tips.

11. The compactor wheel of claim 10, wherein each of the first plurality of plus tips has a width arm about the same length as the length of each of the second plurality of paddle tips.

12. The compactor wheel of claim 1, wherein the center zone has a width about three times a width of either of the first and second edge zones.

13. The compactor wheel of claim 1, wherein the center zone has a width about equal to 40-60% of an overall axial length of the rim.

14. The compactor wheel of claim 1, wherein each of the first and second edge zones has a width about equal to 20-30% of an overall axial length of the rim.

15. A compactor wheel, comprising:
a rim;
a first plurality of tips protruding radially outward from the rim and configured to primarily provide circumferential traction to the rim; and
a second plurality of tips protruding radially outward from the rim and configured to primarily provide lateral traction to the rim,
wherein a number of the first plurality of tips is greater than a number of the second plurality of tips.

16. The compactor wheel of claim 15, wherein the second plurality of tips are located at opposing outer edges of the rim.

17. The compactor wheel of claim 15, wherein the number of the first plurality of tips is about equal to three times the number of the second plurality of tips.

18. The compactor wheel of claim 3, wherein the first and second pluralities of tips are arranged in a helical pattern.

19. The compactor wheel of claim 18, wherein an angular spacing between adjacent tips in the helical pattern is about 10-14°.

20. The compactor wheel of claim 15, wherein a ratio of free space to space consumed by the first and second pluralities of tips is about 5:1.

21. The compactor wheel of claim 15, wherein a ratio of free space to space consumed by the first and second pluralities of tips is about equal to a diameter of the rim divided by 350-to-1.

22. A method of making a compactor wheel, comprising:
joining a first plurality of paddle tips to a center zone of a rim;
joining a second plurality of plus tips to a first edge of the rim; and
joining a third plurality of plus tips to a second edge of the rim,
wherein a number of the first plurality of paddle tips is more than a combined number of the second and third pluralities of plus tips.

23. The method of claim 22, wherein the number of the first plurality of paddle tips is about 50% more than the combined number of the second and third pluralities of plus tips.

24. The method of claim 22, wherein joining the first plurality of paddle tips, the second plurality of plus tips, and the third plurality of plus tips includes welding the first plurality of paddle tips, the second plurality of plus tips, and the third plurality of plus tips in a helical arrangement to an outer surface of the rim.

25. The method of claim 24, wherein welding the first plurality of paddle tips, the second plurality of plus tips, and the third plurality of plus tips in a helical arrangement to an outer surface of the rim includes welding the first plurality of paddle tips, the second plurality of plus tips, and the third plurality of plus tips such that a ratio of free space to space consumed by the first plurality of paddle tips, the second plurality of plus tips, and the third plurality of plus tips is about equal to a diameter of the rim divided by 350-to-1.
